(19) United States
(12) Patent Application Publication
(10) Pub. No.: US 2025/0214799 A1
(43) Pub. Date: Jul. 3, 2025

(54) DOUBLE-TUBE PAPER CUTTER

(71) Applicant: Jianwu XIE, Xiangtan (CN)

(72) Inventor: Jianwu XIE, Xiangtan (CN)

(21) Appl. No.: 18/401,795

(22) Filed: Jan. 2, 2024

(51) Int. Cl. B65H 35/06; B26D 1/02

(52) U.S. Cl. CPC B65H 35/06; B26D 1/025

(57) ABSTRACT

The present disclosure provides a double-tube paper cutter, including a tube body with a through opening on one side, a first half tube cover connected to the tube body at one end and located obliquely above the through opening, a second half tube cover connected to the tube body at one end and located obliquely below the through opening, and a cutting knife mounted at one end, far away from the tube body, of the second half tube cover. An adjusting opening is formed between one end, far away from the tube body, of the first half tube cover and the one end, far away from the tube body, of the second half tube cover. The one end, far away from the tube body, of the second half tube cover is provided with a paper feed gap.

### TECHNICAL FIELD

The present disclosure relates to the technical field of paper product cutting equipment, and particularly relates to a double-tube paper cutter.

### BACKGROUND

Both printing paper and typing paper are commonly used in our work and life. To meet different usage demands, different lengths of paper should be cut usually according to actual demands. Currently, people mainly use scissors or blades to cut paper rolls, resulting in a low cutting efficiency and wasting of defective products due to the frequent occurrence of uneven cut edges. Thus, paper cutters convenient to use are design. However, an existing paper cutter can only cut single-size paper rolls, so the universality is poor.

### SUMMARY

Based on this, it is necessary to provide a double-tube paper cutter adapted to cut at least two sizes of paper rolls to solve the problems of existing paper roll cutting.

A double-tube paper cutter comprises a tube body with a through opening on one side, a first half tube cover connected to the tube body at one end and located obliquely above the through opening, a second half tube cover connected to the tube body at one end and located obliquely below the through opening, and a cutting knife mounted at one end, far away from the tube body, of the second half tube cover; an adjusting opening is formed between one end, far away from the tube body, of the first half tube cover and the one end, far away from the tube body, of the second half tube cover; the one end, far away from the tube body, of the second half tube cover is provided with a paper feed gap, the cutting knife is located in the paper feed gap, and a sharp edge of the cutting knife faces an opening of the paper feed gap; a first-size paper roll storage space is formed inside the tube body, and a second-size paper roll storage space is formed between the first half tube cover and the second half tube cover.

In the double-tube paper cutter, the first-size paper roll storage space is formed inside the tube body, and the second-size paper roll storage space is formed between the first half tube cover and the second half tube cover. Therefore, a paper roll can be selectively placed in the tube body or between the first half tube cover and the second half tube cover according to the size of the paper roll. Afterwards, a paper sheet of the paper roll is pulled for a preset length, fed into the paper feed gap to be in contact with the cutting knife and cut off. Through the arrangement of the through opening and the adjusting opening, the first-size paper roll storage space and the second-size paper roll storage space can be further increased so as to fit paper rolls in a bigger size. Paper rolls can be selectively placed in the storage spaces of the double-tube paper cutter according to the sizes of the paper rolls and then cut. The double-tube paper cutter can be suitable for at least two sizes of paper rolls, thereby having high universality and practicability.

In one embodiment, the first-size paper roll storage space is greater than the second-size paper roll storage space.

In one embodiment, one end, far away from the cutting knife, of the paper feed gap is provided with a guide bevel.

In one embodiment, the second half tube cover is provided with a clamping groove, and the cutting knife is partially located in the clamping groove.

In one embodiment, one end, far away from the tube body, of the first half tube cover is provided with a flanged portion.

In one embodiment, the double-tube paper cutter further comprises a bottom board connected to an outer wall of the tube body and an outer wall of the second half tube cover.

In one embodiment, a first passage is formed between the outer wall of the tube body, the outer wall of the second half tube cover and an inner wall of the bottom board.

In one embodiment, the double-tube paper cutter further comprises a top cover connected to the outer wall of the tube body and an outer wall of the first half tube cover.

In one embodiment, a second passage is formed between an inner wall of the top cover and the outer wall of the tube body, and a third passage is formed between the inner wall of the top cover, the outer wall of the tube body and the outer wall of the first half tube cover.

In one embodiment, a handle is arranged on the top cover and located on a top surface, far away from the second half tube cover, of the top cover.

### BRIEF DESCRIPTION OF DRAWINGS

The accompanying drawings, which constitute a part of this application, are used for providing a further understanding of the present disclosure; and schematic embodiments of the present disclosure and descriptions thereof are intended to explain the present disclosure and are not construed to unduly limit the present disclosure. In the drawings:

FIG. 1 is a schematic view of the double-tube paper cutter according to the present disclosure;

FIG. 2 is a schematic view of the double-tube paper cutter shown in FIG. 1 at another view angle;

FIG. 3 is an amplified schematic view of a circle A of the double-tube paper cutter shown in FIG. 1.

### DETAILED DESCRIPTION OF THE EMBODIMENTS

To facilitate understanding of the present disclosure, the present disclosure will be described more comprehensively below with reference to related drawings. Preferred embodiments of the present disclosure are provided in the drawings. However, the present disclosure may be achieved in various forms, and is not limited to the embodiments herein. On the contrary, these embodiments are provided for a more thorough and comprehensive understanding of the content disclosed in the present disclosure.

It should be noted that when an element is expressed as “fixed to” another element, it may be directly located on another element, or there may be an intermediate element. When an element is expressed as “connected to” another element, it may be directly connected to another element, or there may be an intermediate element at the same time. In addition, the term “and/or” herein is only intended to describe association relationships of related objects, and indicates that there may be three relationships, for example, “A and/or B” may indicate the following three conditions: A exists separately, A and B exist at the same time, and B exists separately.

Unless otherwise defined, all technical and scientific terms used herein have the same meanings as are commonly understood by those skilled in the art of the present disclosure. The terms used in the description of the present disclosure herein are only to describe specific embodiments, for example, “inner”, “outer”, “left”, “right” and similar expressions are only for the purpose of illustration, and are not intended to limit the present disclosure.

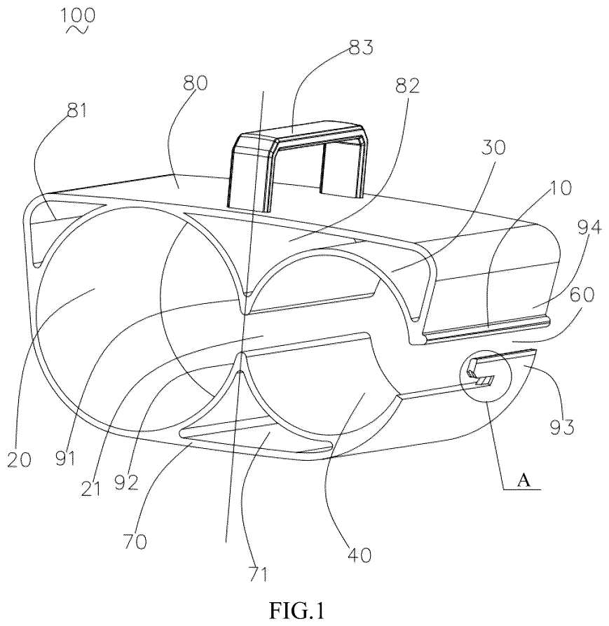

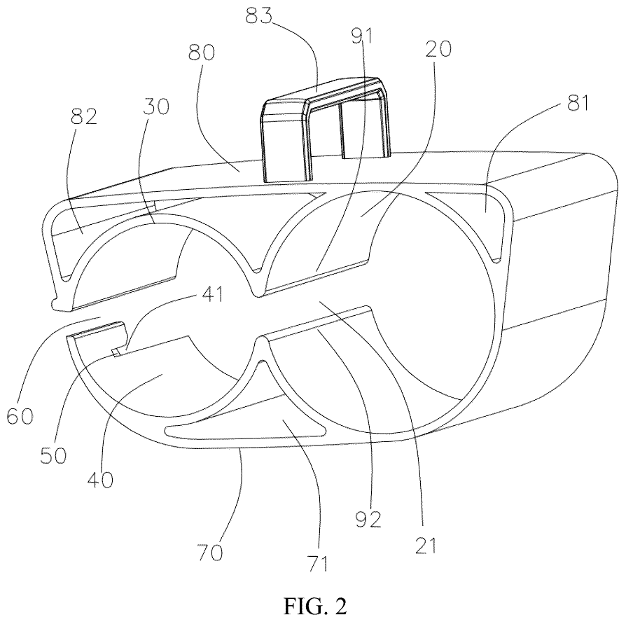

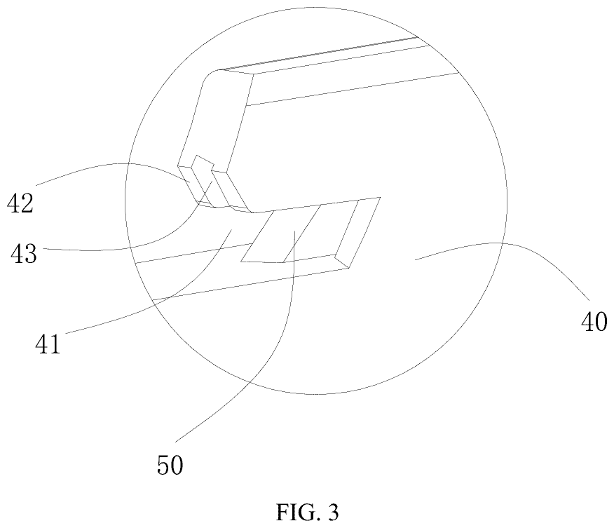

FIG. 1 to FIG. 3 are schematic views of a double-tube paper cutter 100 according to the present disclosure. The double-tube paper cutter 100 includes a tube body 20 with a through opening 21 on one side, a first half tube cover 30 connected to the tube body 20 at one end and located obliquely above the through opening 21, a second half tube cover 40 connected to the tube body 20 at one end and located obliquely below the through opening 21, and a cutting knife 50 mounted at one end, far away from the tube body 20, of the second half tube cover 40. In the embodiment, a first-size paper roll storage space is formed inside the tube body 20, a second-size paper roll storage space is formed between the first half tube cover 30 and the second half tube cover 40, and the first-size paper roll storage space is greater than the second-size paper roll storage space. The tube body 20, the first half tube cover 30 and the second half tube cover 40 are made of durable plastics, thereby being light and durable.

Further, an adjusting opening 60 is formed between one end, far away from the tube body 20, of the first half tube cover 30 and one end, far away from the tube body 20, of the second half tube cover 40. Through the arrangement of the adjusting opening 60 and the through opening 21, there is a certain flexible adjusting space between the tube body 20, the first half tube cover 30 and the second half tube cover 40.

Further, the one end, far away from the tube body 20, of the second half tube cover 40 is provided with a paper feed gap 41, the cutting knife 50 is located in the paper feed gap 41, and a sharp edge of the cutting knife 50 faces an opening of the paper feed gap 41. One end, far away from the cutting knife 50, of the paper feed gap 41 is provided with a guide bevel 42. The guide bevel 42 allows a paper sheet of a paper roll to be fed into the paper feed gap 41, thereby ensuring that the paper sheet is effectively cut.

Further, the second half tube cover 40 is provided with a clamping groove 43, the cutting knife 50 is partially located in the clamping groove 43, so the cutting knife 50 can be conveniently and quickly mounted on the second half tube cover 40. Furthermore, the one end, far away from the tube body 20, of the first half tube cover 30 is provided with a flanged portion 31, and the flanged portion 31 can increase the support area of an end portion of the first half tube cover 30.

The double-tube paper cutter 100 further includes a bottom board 70 connected to an outer wall of the tube body 20 and an outer wall of the second half tube cover 40, and the bottom board 70 can form a planar support bottom on the double-tube paper cutter 100. A first passage 71 is formed between the outer wall of the tube body 20, the outer wall of the second half tube cover 40 and an inner wall of the bottom board 70.

The double-tube paper cutter 100 further includes a top cover 80 connected to the outer wall of the tube body 20 and an outer wall of the first half tube cover 30, and the top cover 80 forms a force application surface on the double-tube paper cutter 100, A second passage 81 is formed between an inner wall of the top cover 80 and the outer wall of the tube body 20, and a third passage 82 is formed between the inner wall of the top cover 80, the outer wall of the tube body 20 and the outer wall of the first half tube cover 30, which can ensure the overall support strength and save materials overall.

Further, a handle 83 is arranged on the top cover 80, and the handle 83 is located on a top surface, far away from the second half tube cover 40, of the top cover 80, The handle 83 is located at a position, opposite to the through opening 21, of the top cover 80. When in use, the handle 83 is pressed downwards to apply force to the bottom board 70 correspondingly.

The first-size paper roll storage space formed inside the tube body 20 is suitable for a paper roll with a diameter greater than 8 cm. The paper sheet is pulled from the through opening 21 in the middle into the paper feed gap 41 and cut through the cutting knife 50. The second-size paper roll storage space formed between the first half tube cover 30 and the second half tube cover 40 is suitable for a paper roll in a normal size. The paper sheet is pulled into the paper feed gap 41 and cut through the cutting knife 50.

In the double-tube paper cutter, the first-size paper roll storage space is formed 20 inside the tube body 100, and the second-size paper roll storage space is formed between the first half tube cover 30 and the second half tube cover 40. When in use, the paper roll can be selectively placed in the tube body 20 or between the first half tube cover 30 and the second half tube cover 40 according to the size of the paper roll. Afterward, the paper sheet of the paper roll is pulled for a preset length, fed into the paper feed gap 41 to be in contact with the cutting knife 50 and cut off. Through the arrangement of the through opening 21 and the adjusting opening 60, the first-size paper roll storage space and the second-size paper roll storage space can be further increased so as to fit paper rolls in a bigger size. Paper rolls can be selectively placed in the storage spaces of the double-tube paper cutter 100 according to the sizes of the paper rolls and then cut. The double-tube paper cutter can be suitable for at least two sizes of paper rolls, thereby having high universality and practicability.

The technical features of the above embodiments can be combined arbitrarily. To simplify the description, possible combinations of the technical features of the above embodiments are not completely described. However, as long as there is no contradiction between the combinations of these technical features, the combinations should be considered to fall within the scope of the present specification.

The above embodiments only express several embodiments of the present disclosure, and relatively specific and detailed descriptions thereof are provided. However, these embodiments cannot be understood as limitations on the scope of the patent of the present disclosure. It should be noted that those of ordinary skill in the art can make some modifications and improvements without departing from the idea of the present disclosure, and all these modifications and improvements should fall within the scope of protection of the present disclosure. Therefore, the scope of protection of the patent for the present disclosure should be subject to the claims.

1. A double-tube paper cutter, comprising a tube body with a through opening on one side, a first half tube cover connected to a first end of the tube body and located obliquely above the through opening, a second half tube cover connected to a second end of the tube body and located obliquely below the through opening, and a cutting knife mounted at a third end of the second half tube cover; an adjusting opening being formed between a fourth end of the first half tube cover and the third end of the second half tube cover; the third end of the second half tube cover being provided with a paper feed gap, the cutting knife being located in the paper feed gap, and a sharp edge of the cutting knife facing an opening of the paper feed gap; a first-size paper roll storage space being formed inside the tube body, and a second-size paper roll storage space being formed between the first half tube cover and the second half tube cover;
wherein the first-size paper roll storage space is greater than the second-size paper roll storage space; and
the through opening runs along a longitudinal direction of the tube body; the through opening has a spacing distance when the first end and the second end of the tube body are in a rest position; the first end and the second end of the tube body are in the rest position when no force is applied to the double-tube paper cutter; the first end and the second end of the tube body are adjustable from the rest position to a first working position or a second working position; the spacing distance of the through opening increases and allows a paper roll to be placed within the first-size paper roll storage space in response to the first end and the second end of the tube body being adjusted from the rest position to the first working position; the spacing distance of the through opening decreases and allows a paper sheet of the paper roll placed within the first-size paper roll storage space to pass through and be cut by the cutting knife in response to the first end and the second end of the tube body being adjusted from the rest position to the second working position.

2. (canceled)

3. The double-tube paper cutter according to claim 1, wherein an opening portion of the paper feed gap is provided with a guide bevel, and the guide bevel is away from the cutting knife.

4. (canceled)

5. The double-tube paper cutter according to claim 1, wherein the fourth end of the first half tube cover is provided with a flanged portion.

6. The double-tube paper cutter according to claim 1, further comprising a bottom board connected to an outer wall of the tube body and an outer wall of the second half tube cover.

7. The double-tube paper cutter according to claim 6, wherein a first passage is formed between the outer wall of the tube body, the outer wall of the second half tube cover and an inner wall of the bottom board.

8. The double-tube paper cutter according to claim 1, further comprising a top cover connected to an outer wall of the tube body and an outer wall of the first half tube cover.

9. The double-tube paper cutter according to claim 8, wherein a second passage is formed between an inner wall of the top cover and the outer wall of the tube body, and a third passage is formed between the inner wall of the top cover, the outer wall of the tube body and the outer wall of the first half tube cover.

10. The double-tube paper cutter according to claim 8, wherein a handle is arranged on the top cover and located on a top surface of the top cover, and the top surface of the top cover is away from the second half tube cover.
